(19) United States
(12) Patent Application Publication
(10) Pub. No.: US 2018/0129920 A1
(43) Pub. Date: May 10, 2018

(54) System and Method for Associating Data With a Firearm

(71) Applicants: Graham C. Henry, Royse City, TX (US); Cameron M. Henry, Rockwall, TX (US)

(72) Inventors: Graham C. Henry, Royse City, TX (US); Cameron M. Henry, Rockwall, TX (US)

(21) Appl. No.: 15/795,008

(22) Filed: Oct. 26, 2017

Related U.S. Application Data
(60) Provisional application No. 62/413,310, filed on Oct. 26, 2016.

(51) Int. Cl. G06K 17/00; G06Q 10/00; G06K 7/10; G06K 7/14; F41A 17/06

(52) U.S. Cl. CPC G06K 17/0022; G06Q 10/20; G06K 7/10297; G06F 17/30879; G06K 7/1413; G06K 7/10762; F41A 17/063; G06K 7/1417

(57) ABSTRACT

A system and method for tracking, recording, maintaining, and scheduling maintenance for firearms and other tactical assets, with full review capabilities in which desired information is preferably backed up to easy-to-use and easy-to-edit cloud-based database. The desired information is stored in, or associated with, computer-readable markings engraved with fiber laser on, or in RFID's positioned on or embedded within, the firearm or asset. The information is preferably scanned and uploaded for storage in the cloud-based database, allowing for full accountability of firearms and assets.

### CROSS-REFERENCE TO RELATED APPLICATIONS

This application claims the benefit of U.S. Provisional Application No. 62/413,310, filed Oct. 26, 2016, which application is hereby incorporated herein by reference, in its entirety.

### TECHNICAL FIELD

The invention relates generally to associating data with a tactical asset and, more particularly, to a system and method for associating data, such as identification information, to tactical assets, such as firearms.

### BACKGROUND

It is well-known that tactical assets, such as pistols, rifles, stun guns, Tasers®, and guns generally, collectively referred to herein as “firearms”, can provide its user with considerable physical force, which can be used for legitimate defensive and protective ends. However, if firearms are not properly secured, they could be stolen or otherwise misappropriated, and potentially pose a significant public danger. Therefore, proper security and accountability of firearms is important. Accordingly, what is needed is an accountability system and method for readily tracking, recording, maintaining, and accessing information relating to firearms, and preferably also for periodically scheduling a full review in which all information relating to firearms is maintained and accounted for.

### SUMMARY

The present invention, accordingly, provides an accountability system and method effective to readily track, record, and maintain encoded information relating to firearms, and to schedule a full review of same periodically. This is achieved by engraving onto a firearm a computer-readable code, or marking, such as bar code or a 2D code such as QR code or Data Matrix code. The marking is preferably engraved using a fiber laser, and the information stored in the marking may be any suitable information, such as a firearm owner's name, address, last four digits of their social security number, concealed handgun license (“CHL”) number, business name, personal message for gifting, or any other text desired. Such information is preferably stored and backed up to an easy-to-use and easy-to-edit cloud-based database.

In an alternative embodiment of the invention, the encoded information is embedded in a radio frequency identification (RFID) chip positioned on or embedded within the firearm.

In a further embodiment of the invention, the encoded information is embedded in both a visible marking and an RFID chip embedded within the firearm.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 exemplifies a laser etching a visible computer-readable marking onto a firearm in accordance with principles of the present invention;

FIG. 2 exemplifies a scanner reading the marking of FIG. 1 and also an RFID chip optionally embedded in the firearm;

FIG. 3 exemplifies how information associated with the marking may be reviewed and/or edited; and

FIG. 4 is a schematic diagram which exemplifies how firearms may be linked to a database in accordance with principles of the present invention.

### DETAILED DESCRIPTION

Refer now to the drawings wherein depicted elements are, for the sake of clarity, not necessarily shown to scale and wherein like or similar elements are designated by the same reference numeral through the several views. In the interest of conciseness, well-known elements may be illustrated in schematic or block diagram form in order not to obscure the present invention in unnecessary detail, and details concerning various other components known to the art, such as firearms, bar codes, QR codes, Data Matrix codes, radio frequency identification (RFID) technology, scanners, and the like, have not been shown or discussed in detail inasmuch as such details are not considered necessary to obtain a complete understanding of the present invention, and are considered to be within the skills of persons of ordinary skill in the relevant art.

As used herein, the term “substantially” is to be construed as a term of approximation. Additionally, the term “firearm” shall be used herein in a collective manner to refer to rifles, pistols, stun guns, Tasers®, guns generally, and the like.

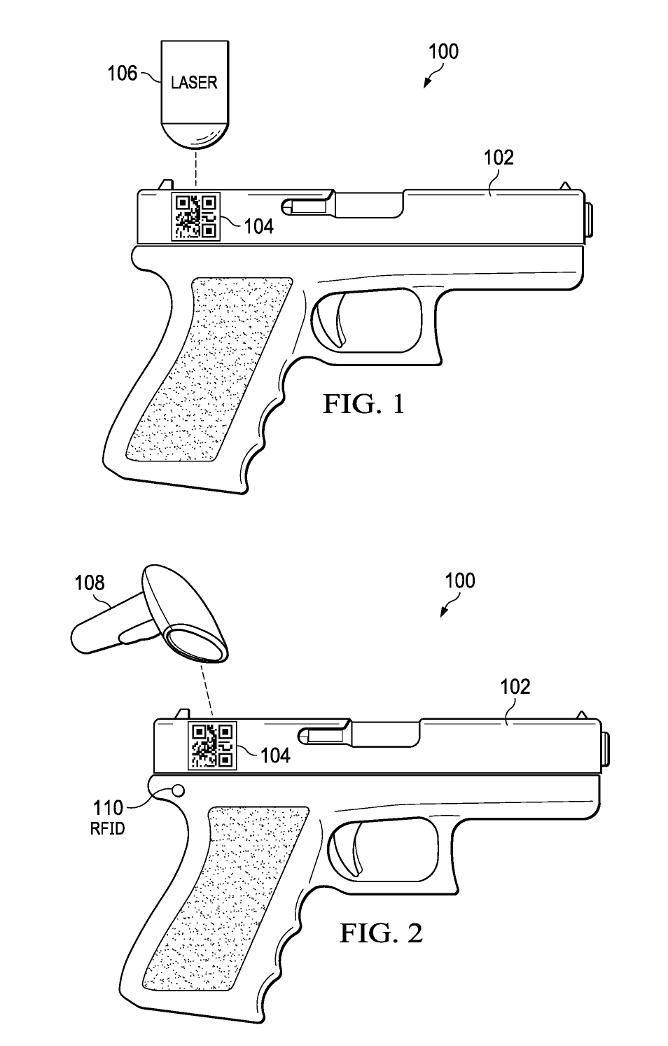

Referring to FIG. 1 of the drawings, the reference numeral 100 generally refers to a system for applying encoded information to a firearm 102, in accordance with features of the present invention. The encoded information may comprise any data desired. For example, encoded information may include a firearm owner's name, address, last four digits of their social security number, concealed handgun license (“CHL”) number, business name, personal message for gifting, or any other text desired.

In accordance with features of the invention, the encoded information may be stored in a visible computer-readable marking 104, such as a bar code, a QR code, a Data Matrix, or the like, to which the encoded information is applied and/or linked via a unique ID code to a database (as discussed below with respect to FIG. 4) that stores at least a portion of the encoded information and/or additional information not stored in the marking.

Marking 104 is preferably applied by means of laser 106, which laser is preferably a fiber laser. To be effective, though, marking 104 must have sufficient contrast so that dark and light portions of the marking are distinguishable by a scanner. There are a number of different ways that contrast of the computer-readable marking 104 may be made visible, depending on the finish of the firearm. If the firearm is painted, marking 104 will preferably be laser-engraved at about 2000 mm/ps so that only the paint is removed and the silver of the metal under it shows. If the firearm is nickel-plated or fabricated from stainless steel, marking 104 may be applied by moving laser 106 at a slower speed so the marking is etched a little deeper into the metal and to provide a textured feel, thereby providing sufficient contrast to be read. Alternatively, marking 104 could be annealed onto the gun by way of deflecting the laser's focus at 5-10 mm so that the laser colors, rather than engraves, the marking into the firearm metal. The color may be controlled by the amount of heat applied to the metal which raises the temperature of the metal, just as an oxy/acetylene torch can do to metal.

FIG. 2 shows how computer-readable marking 104, once applied to firearm 102, may be read using a scanner 108, which is preferably a 2D scanner. Scanner 108 may be a dedicated scanner, a camera on a “smart” phone, or the like. While not shown, scanner 108 is preferably coupled for data communication to a database, which, as discussed in further detail with respect to FIG. 4 below, is preferably cloud-based and effective for storing data related to marking 104, as discussed in further detail below with respect to FIG. 4.

In an alternative embodiment of the invention, a radio frequency identification (RFID) chip 110 is securely positioned on, or embedded within, the firearm, and the encoded information is embedded in the RFID chip. A scanning antenna and transceiver (not shown) are then used in a conventional manner to read the encoded information stored on or in connection with the RFID chip.

In a further embodiment of the invention, encoded information is embedded in both a visible marking 104 and an RFID chip 110 embedded within the firearm.

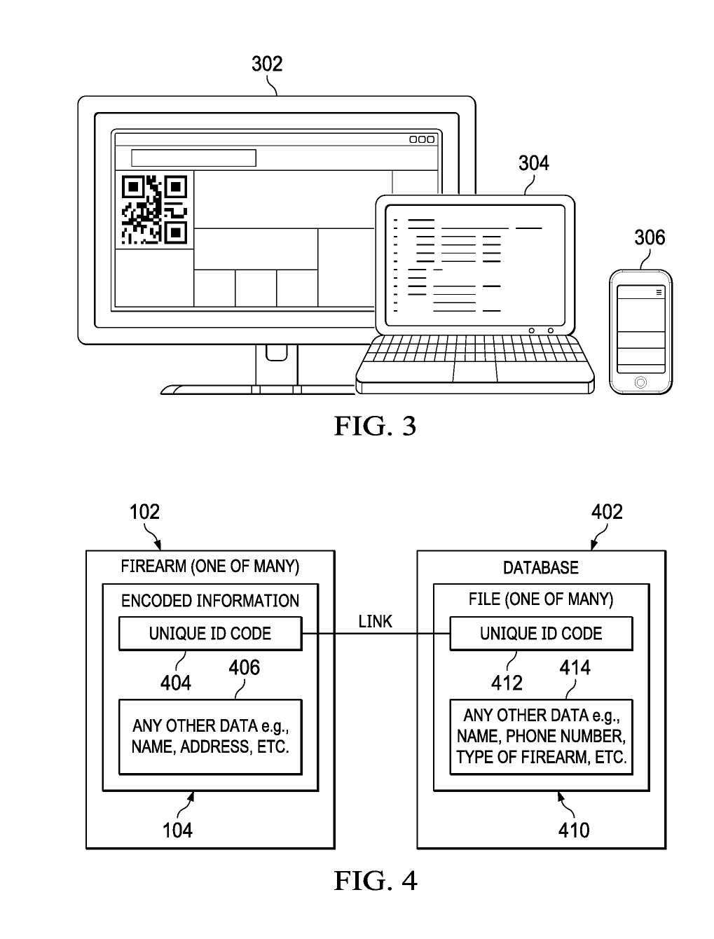

FIG. 3 exemplifies three types of computer display interfaces that may be utilized to read encoded information stored (e.g., in the database) on or in connection with marking 104 or RFID 110. By way of example, but not limitation, a person may utilize a desktop computer and monitor 302, a laptop computer screen 304, or a mobile “smart” phone screen 306 to view encoded information stored on or in connection with marking 104 and/or RFID 110. While not shown, output devices may include printers for printing reports, and input devices, such as a conventional keyboard and mouse, may be used to input or alter encoded information.

FIG. 4 is a schematic diagram which exemplifies an optional feature of the invention for linking at least one firearm 102 to a database 402. As discussed above, firearm 102 is preferably provided with an RFID chip 110 or marking 104 having encoded information (e.g., bar code, QR code, Data Matrix, or the like), the marking being engraved onto the surface of the firearm 102. While the marking 104 is depicted in FIG. 4, it is understood that the marking 104 could be supplemented by or supplanted by RFID 110. As further discussed above, the encoded information 104 may include a unique identification (“ID”) code 404, along with any other desirable information 406. A database 402, preferably cloud-based, includes at least one file 410 configured for storing information about the at least one firearm 102. The information stored in database 402 includes a unique ID code 412 and any other desirable information 414. By way of example, but not limitation, information 406 and 414 may each include any of an owner name, address, phone number, type of firearm, GPS location of firearm, type of firearm, CHL (concealed handgun license) number, LTC (license to carry) number, precinct, platoon, division or branch of military, weapon name, group name, asset ID number, and the like. The unique ID code 412 must match the unique ID code 404 to thereby link each at least one file 410 with each respective at least one firearm 102. The unique ID code could be a serial number assigned to a firearm by its manufacturer, an encrypted version of the manufacturer serial number, or it could be generated in any conventional manner as long as it maintains uniqueness in database 402, and it could comprise any combination of alphanumeric and/or other special characters. Database 402 could be a privately hosted database (e.g., by a single civilian, gun hobbyist, company, or the like) and/or it could be a public database, such as for a security agency, a police department, and/or a national or global firearm registry. Database 402 could also be operated by an organization using it, and/or it could be centrally hosted by a third party, as SaaS (“Software as a Service”).

In operation, as shown in FIG. 1, encoded information is first engraved onto the surface of the firearm 102, preferably by way of a fiber laser 106. Alternatively, or additionally, as discussed above with respect to FIG. 2, an RFID chip 110 may be positioned on or embedded within the firearm. By way of example, but not limitation, such encoded information may comprise the customer's name, address, last four digits of their social security number, or any other custom message, as well as an optional unique ID code, and the marking may comprise a bar code, a QR code, a Data Matrix, or the like, that can be easily scanned and read by a scanner, as discussed in the following.

Once the marking is applied to a firearm, it is then preferably scanned using a 2D scanner (e.g., a code scanner, a “smart” phone camera). In one embodiment, the information is communicated to a computer configured to decode the encoded information residing in the marking, and then displaying the decoded information on a display, as shown in FIG. 3.

In an alternative embodiment, the scanned marking is then communicated to a custom software database, preferably residing in the cloud and accessible via the Internet, that will preferably allow the data to be altered for a new issue of a firearm, a reissue of a firearm, checking out of a firearm, returning of a firearm, and the like. The program preferably includes other features, such as profile management of employees, firearm management, and the ability to add a firearm with full description and information. All information is preferably stored with a date and time stamp which is linked to a calendar so a user can obtain a full view of a firearm and its full history with full user accountability, as well as a maintenance folder for all firearms with open editable tabs to input any and all firearm data that may be needed, including maintenance scheduling and ability to print a work order to repair a firearm. All data will preferably be printable to spreadsheets for analysis.

Once the encoded information is scanned and uploaded to the cloud server, then, as shown in FIG. 3, a user may read and/or alter the information to suit the user's specification, preferably including customizing such things as the information input and output format and menu options. Reports may be generated and printed showing encoded information in a database format or in a spreadsheet format for full data analysis. Reports may include a calendar-based history of any particular firearm.

The system of the present invention may be sold as a kit to gun stores with training on use, and may include fully customizable personal information in encoded form. Operation of the present invention may be provided as a service at gun stores and gun shows that allow customers to have their personal information engraved or stored onto a firearm using a computer-readable marking or RFID. Alternatively, an owner of a firearm may drop-off or mail in the firearm to a business that would engrave the marking or code the RFID with desired encoded information, and then the owner could link the marking to the desired information, which information the user or business would preferably fill in through the website or mobile phone application (“app”). The app or website would preferably include a link to click on to save the scanned information to a database residing on, or accessed by, the app or website.

The invention may also be utilized by police departments, private security agencies, military departments, and any other organizations that use firearms, to issue, track, and keep a full record of issued firearms and any other tactical assets.

It is understood that the present invention may take many forms and embodiments. Accordingly, several variations may be made in the foregoing without departing from the spirit or the scope of the invention. For example, its use is not limited to firearms, but could be readily adapted for use with other assets, particularly tactical assets, such as vehicles (e.g., Humvees, MRAPs, squad cars, patrol cars, and the like), weapons, and special tactical assets, such as drones and robotic equipment. The database storing the encoded information may be adapted to include a maintenance folder to schedule repairs or maintenance for assets with routine maintenance and work order scheduling. A portion or all of the information applied to a firearm could be applied in a form readable by a human.

In a further variation and embodiment of the invention, the invention may be used to track persons, such as employees, by way of user (i.e., employee) name and password, or by way of ID cards which may be entered or scanned into a database. This embodiment could be used to clock-in and clock-out employees for purposes of accounting and payroll, preferably using cloud software which would integrate with accounting programs such as Quickbooks®. Additionally, this embodiment could be used to track who checks-out and checks-in issued equipment, such as tactical gear.

In a still further variation and embodiment of the invention, a Global Positioning System (“GPS”) transmitter and accelerometer are preferably secured to an asset, e.g., a firearm, and are preferably powered by battery. The battery is preferably a small, short-life rechargeable battery that includes micro-mechanisms effective for converting movement of the asset to electrical energy for charging the battery. In operation, movement of the asset charges the battery and would be detected by the accelerometer for activating the GPS to determine and transmit the GPS location to a designated person. For example, if the GPS transmitter is secured to a father's firearm, the father tells a son to not move the firearm, and the son moves the firearm, then the GPS would be activated and automatically send a signal (e.g., via a push notification) to an app on the father's mobile phone informing the father that the firearm has been moved, e.g., by the son or a thief. In another application, a receiver is integrated into the transmitter and, if the location of the asset, such as a firearm, is unknown, a signal may be sent to the receiver to activate the GPS and transmit a signal indicative of the location of the asset. Still further, the GPS on the asset, such as a firearm, may be configured to geofence or geolock into its position, so that if the asset is moved outside of the geofence or moved from its locked position, it would send an alert to a designated person indicating, for example, the firearm may have been stolen.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A firearm identification system comprising:
a firearm;
a marking formed on the firearm, the marking containing information for tracking, recording, maintaining, and scheduling maintenance for the firearm.

2. The firearm of claim 1 wherein the information is encoded information.

3. The firearm of claim 1 wherein the information comprises at least one of owner name, address, phone number, type of firearm, GPS location of firearm, type of firearm, CHL (concealed handgun license) number, LTC (license to carry) number, precinct, platoon, division or branch of military, weapon name, group name, and asset ID number.

4. The firearm of claim 1 further comprising a laser configured for forming the marking on the firearm.

5. The firearm of claim 1 wherein the marking is one of a bar code, a QR code, and a Data Matrix, the marking being configured for retaining the information.

6. The firearm of claim 1 wherein the marking is an RFID chip embedded in the firearm, the RFID chip being configured for retaining the information.

7. The firearm of claim 1 further comprising a scanner for reading the marking on the firearm.

8. The firearm of claim 1 further comprising:
a scanner for reading the marking on the firearm; and
a computer coupled in data communication to the scanner for receiving and displaying the data read by the scanner.

9. The firearm of claim 1 further comprising:
a scanner for reading the marking on the firearm; and
a database coupled in data communication to the scanner for receiving and storing the data read by the scanner.

10. The firearm of claim 1 further comprising:
a scanner for reading the marking on the firearm; and
a cloud-based database coupled via the Internet in data communication to the scanner for receiving and storing the data read by the scanner.

11. The firearm of claim 1 wherein the information includes a unique ID code, and wherein the firearm further comprises:
a scanner for reading the marking on the firearm; and
a database coupled in data communication to the scanner for receiving and storing the data read by the scanner according to the unique ID code associated with the firearm.

12. The firearm of claim 1 further comprising:
a scanner for reading the marking on the firearm;
a database coupled in data communication to the scanner for receiving and storing the data read by the scanner; and
a monitor for displaying the data read by the scanner.

13. The firearm of claim 1 further comprising:
a scanner for reading the marking on the firearm; and
a database coupled in data communication to the scanner for receiving and storing the data read by the scanner, wherein the database is configured for scheduling maintenance for the firearm.

14. A method for identifying a firearm, the method comprising steps of:
forming a marking on the firearm, the marking including encoded information;
scanning the marking to retrieve the encoded information;
communicating the encoded information to a computer to generate decoded information; and
displaying the decoded information.

15. The method of claim 14 wherein the step of forming includes using a laser to form the marking on the firearm.

16. The method of claim 14 wherein the marking is one of a bar code, a QR code, and a Data Matrix, the marking being configured for retaining the information.

17. The method of claim 14 wherein the marking is an RFID chip embedded in the firearm, the RFID chip being configured for retaining the encoded information.

18. The method of claim 14 wherein the information comprises at least one of owner name, address, phone number, type of firearm, GPS location of firearm, type of firearm, CHL (concealed handgun license) number, LTC (license to carry) number, precinct, platoon, division or branch of military, weapon name, group name, and asset ID number.

19. The method of claim 14 wherein the computer is cloud-based and accessed via the Internet.

20. The method of claim 14 wherein the computer includes a database and the encoded information includes a unique ID code, and the method further comprises a step of storing the information in the database indexed to the unique ID code.
